(19) United States
(12) Patent Application Publication
(10) Pub. No.: US 2019/0341951 A1
(43) Pub. Date: Nov. 7, 2019

(54) WEARABLE MOBILE DEVICE HAVING PROTECTIVE ENCLOSURE AND HOT SWAP BATTERY CONFIGURATION

(71) Applicant: Rufus Labs, Inc., West Hollywood, CA (US)

(72) Inventor: Gabriel Grifoni, Los Angeles, CA (US)

(73) Assignee: Rufus Labs, Inc., West Hollywood, CA (US)

(21) Appl. No.: 15/969,487

(22) Filed: May 2, 2018

(51) Int. Cl. H04B 1/3827; H04M 1/02; H04B 1/3883; H04B 1/3888

(52) U.S. Cl. CPC H04B 1/385; H04M 1/0274; H04M 1/0266; H04B 1/3888; H04B 1/3883

(57) ABSTRACT

A mobile device is disclosed with a plurality of layered, protective shells that provide impact resistance, liquid resistance, and durability when subject to turbulent conditions and environments. The mobile device contains a hot-swap, dual battery configuration, wherein one of the batteries is detachable and replaceable with another fully charged battery while the mobile device remains powered, thereby enabling the user to forego the need for a power supply for an extended use of the mobile device. Moreover, the mobile device can contain wings attached to the device enclosure, wherein straps, bands, and/or clasps can be inserted within the wings and secured about a user's body, such as a wrist, providing the user with easy accessibility to the device.

### FIELD OF THE INVENTION

The present invention relates generally to mobile devices and, more particularly, to wearable mobile devices.

### BACKGROUND OF THE INVENTION

The proliferation of mobile device usage in the everyday life of consumers was in part due to the enhanced accessibility to technology such as computing power and connectivity. The leisure and social benefits provided by mobile devices are readily apparent in the current world given the popularity of social network sites, and the entertainment available such as streaming videos or surfing the internet. The working environment has also changed through mobile devices, building upon the benefits of email accessibility, which was one of the original proponents in fueling the use of mobile devices. The ability to perform tasks on the go and remain connected wherever a person may be is a staple advantage that businesses and workers can exploit, as workers are not tied to a specific location, such as an office, to get work done.

With portability being the defining feature of mobile devices, manufacturers are continually seeking ways to efficiently design a mobile device that provides the most amount of features in the smallest and most compact structure. As a result, mobile devices, particularly smart phones, have become thinner, while expanding the screen size end to end of a given device. Battery life is another feature manufacturers seek to extend, but must often compete with the shrinking mobile device body, thereby requiring the advent for smaller, more efficient batteries.

The compact design of mobile devices has however somewhat compromised the protective casing surrounding the mobile device. Although newer technologies have allowed for better water resistance and increased shatterproof screens, such mobile devices are tailored for ordinary hand held use by a consumer, and not for physically demanding activities or rugged environments that may present all sorts of adverse conditions, such as rain, dust and/or snow storms. Moreover, improved battery life is still limited. For most people, this may be sufficient considering they may have easy access to a power source at some point in their day.

However, the working community that involves more physically demanding activities are at a disadvantage when seeking to streamline mobile devices as part of the respective working environment. Industries that involve personnel working in the field, including shipping, construction and manufacturing facilities, can benefit with the use of an easily accessible mobile device to perform a variety of tasks, e.g., track cargo, monitor construction activity progress, or oversee equipment operations, among others.

Such activities may, however, subject their mobile device to harsh conditions, from the climate or workplace environment. Moreover, an employee may be impeded by the need to have access to a power source to prevent interruptions in the mobile device operation.

It should, therefore, be appreciated that there exists a need for a mobile device encapsulated in a protective body to withstand rugged environments, and that is capable of operating for an extended period of time without requiring a power source for charging a battery. The present invention fulfils this need and others.

### SUMMARY OF THE INVENTION

Briefly, and in general terms, the invention provides a mobile device configured with protective shells that provide liquid and shock resistance, enabling the device to be used while performing physically demanding activities and/or while in rugged environments. The mobile device further includes a hot-swap, dual battery configuration, thereby extending the device usage time between battery charging requirements.

More specifically, by example and not limitation, the mobile device body includes a bottom shell, a middle shell that can include a middle shell over-mold shell, and a top shell that can include a top shell over-mold shell. Each of the shells are constructed with materials that together, provide a combination of characteristics such as high impact-resistance, high heat-resistance, and abrasion resistance, among others. As such, the shells provide a liquid resistant encapsulation for a battery layer, a circuit layer, and a top layer. The battery layer, located within the bottom shell, houses two batteries that are separated by internal barriers within the bottom layer. The circuit layer, located within the middle layer, houses the internal circuit board, receiving power from the batteries and sending information to the top layer. The top layer, located within the middle shell and top shell, houses the display screen for the user.

In a detailed aspect of an exemplary embodiment, the shells are coupled to one another using screws attached to the top shell, which are inserted through the middle shell and into threaded openings contained on the bottom shell. Moreover, the interface between the middle shells and the top and bottom shells each contain a gasket to ensure an adequate seal is formed when the shells are mated.

In another detailed aspect of an exemplary embodiment, the mobile device includes an internal battery and a swappable battery, each separately capable of powering the mobile device. Moreover, the swappable battery is accessible through a removable battery door on the bottom shell, thereby enabling the swappable battery to be replaceable and removable so as to be separately charged. In this manner, the dual batteries enables the user to hot swap the batteries, i.e., replace a drained swappable battery with a fully charged battery without the need for the device to be powered down.

In yet another detailed aspect of an exemplary embodiment, the mobile device contains a wing attached to both sides of the device. The wings can each further contain an opening that enables one or more straps, bands, and/or clasps to be inserted within the wing openings, and around a user's body, such as a wrist, thereby enabling the mobile device to be secured to the user and worn.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a side view of a mobile device in accordance with the invention, depicting a protective enclosure, along with a strap inserted through a wing affixed the mobile device, wherein the strip is secured to a user's wrist.

FIG. 2 is an exploded view of a mobile device in accordance with the invention, depicting components of the mobile device separated from one another.

FIG. 3A is a rear perspective view of the mobile device of FIG. 2, depicting a battery door in place on the bottom shell back cover.

FIG. 3B is a rear perspective view of the mobile device of FIG. 2, depicting a battery door removed from the bottom shell back cover.

FIG. 4 is a side perspective view of the mobile device of FIG. 2, depicting the bezel on the top shell.

FIG. 5 is a rear perspective view of the mobile device of FIG. 2, depicting wings with perforation attached to the bottom shell.

### DETAILED DESCRIPTION OF THE PREFERRED EMBODIMENTS

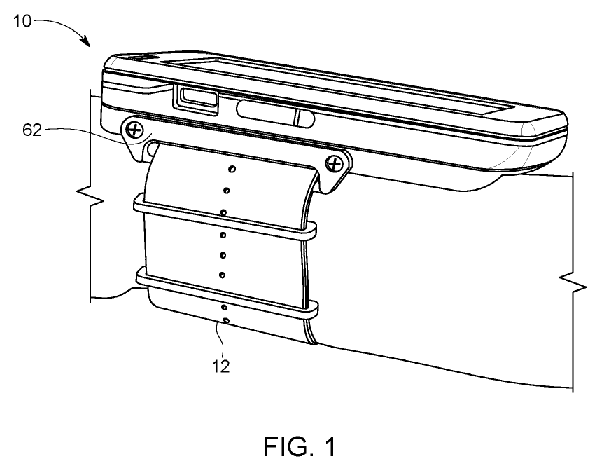

Referring now to the drawings, and particularly FIG. 1, there is shown a mobile device 10 configured with a protective enclosure to the device internals for resistance to impact, shock, liquid penetration, and other adverse conditions. The mobile device 10 further comprises a hot swap, multiple battery configuration, enabling for the device to be used for an extended period of time without the need to be recharged. The device can be configured with strap(s) 12, band(s), and/or one or more clasps inserted through a perforation of one or more wings 62 attached to the device protective enclosure, thereby enabling the mobile device to be secured about a user's wrist. As such, the mobile device 10 is equipped to provide operational reliability and convenient accessibility for a user that may undertake physically demanding activities, encounter adverse environmental conditions, and/or be inaccessible to a power source for prolonged period.

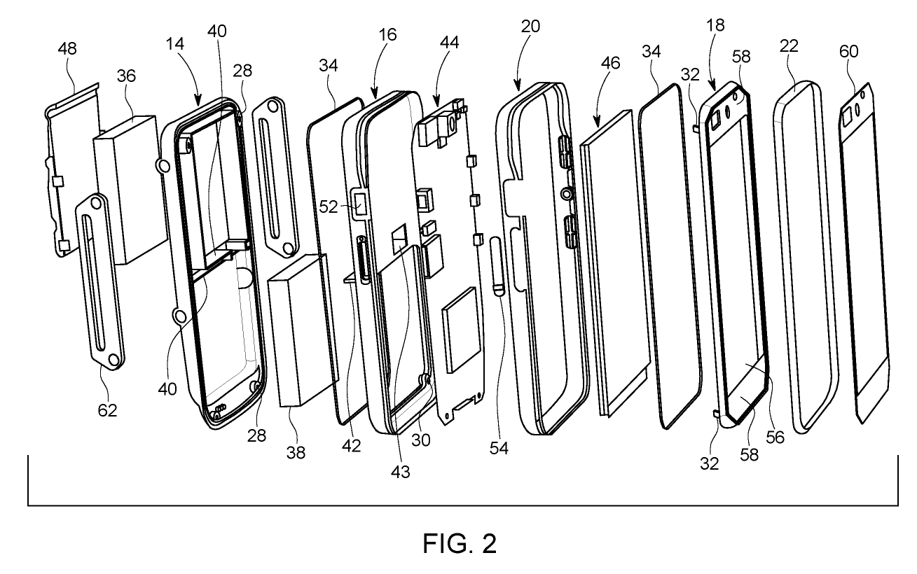

With reference now to FIG. 2, the mobile device 10 includes a bottom shell 14, a middle shell 16 coupled with a middle shell over-mold shell (middle shell OMS) 20, and a top shell 18 coupled with a top shell over-mold shell (top shell OMS) 22. The shells in concert provide an encapsulating protection for the mobile device 10. The bottom shell 14, middle shell 16, and top shell 18 are coupled together with four screws 32, with one screw located within each of the four inner corners of the top shell 18. The four inner corners of the middle shell 16 each contain an opening 30 enabling the four screws 32 to pass through the middle shell 16, and be secured i.e. screwed, within a respective threaded, corner opening 28 of the bottom shell 14. Moreover, a gasket 34 is placed between the bottom shell 14 and middle shell 16, as well as, between the top shell 18 and the middle shell 16, such that when the screws 32 are secured, the gaskets are squeezed in place. The gaskets 34 can be constructed with silicone, thus providing high and low temperature resistance. The gaskets 34 ensure an adequate seal is formed between the shells when coupled together, such that the shells provide a leak-proof encapsulation for the mobile device, thereby helping prevent liquid penetration to the mobile device interior.

With continued reference to FIG. 2, the mobile device 10 uses the shells as a base or platform to house component(s) driving its computing power and operation. A bottom layer located within the bottom shell 14 houses two batteries 36, 38, which are located in separate compartments. In the present embodiment, the compartments are separated by three internal barriers 40,42, two 40 of which are located on the bottom shell 14, and one 42 located on the middle shell 16. The middle shell internal barrier 42 is configured to be inserted in the space between the two internal barriers 40 on the bottom shell. As such, the compartments that house the batteries 36,38 are separated from each other. A middle layer located within the middle shell 16 houses the internal circuit board 44, containing the core computing power along with the auxiliary components, including a camera, speakers, and connections such as an SD card receiver. The internal circuit board 44 receives power from the batteries 36,38. A top layer located between the middle shell 16 and top shell 18 houses the display screen 46 that receives information from internal circuit board 44.

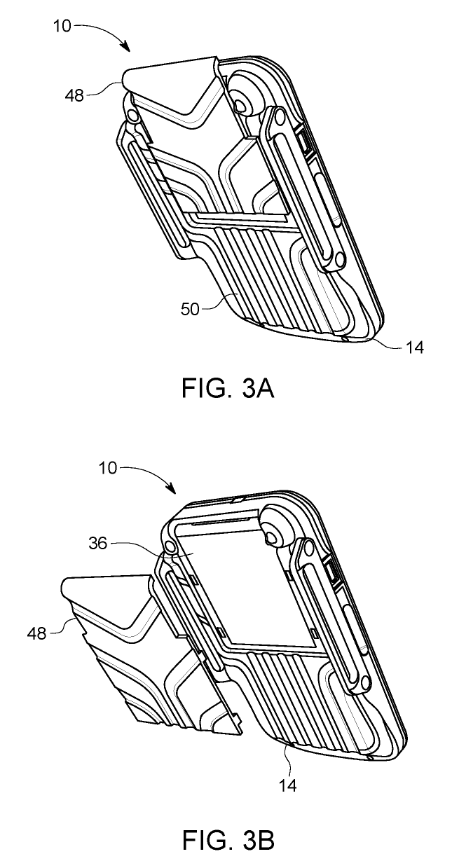

With reference to FIGS. 3A-3B, the bottom shell 14 further includes a back cover 50 that will enclose the bottom layer of the mobile device 10. The back cover 50 of the bottom shell may include a removable portion (battery door 48) providing access to an internal portion of the mobile device, described further below. The bottom shell 14 can be constructed using a combination of polycarbonate and acrylonitrile-butadiene-styrene material (PC-ABS). Polycarbonates provide high-impact resistance and high heat resistance, while maintaining a durable structure that can undergo large plastic deformations without cracking or breaking. Acrylonitrile-butadiene-styrene (ABS) materials also provide impact resistance, heat resistance, and toughness.

With reference now to FIG. 2 and as aforementioned, the middle shell 16 can include a middle shell OMS 20. The middle shell 16 contains a back cover that covers mainly the top half of the middle shell 16, separating the internal circuit board 44 from a swappable battery 36, with the exception for a perforation 43 located in the top half that enable swappable battery 36 contacts to be exposed to the internal circuit 44. The back cover for the bottom half of the middle shell 16 contains a large perforation, enabling operative communication between an internal battery 38 and the internal circuit board 44. The middle shell 16 further defines recessed openings 52 along the top and sidewalls to provide connectivity access points to the internal circuit board 44 for peripheral devices compatible with the mobile device 10, such as connections a micro USB and/or SD card. The middle shell 16 can be constructed with PC-ABS, thereby providing an additional impact resistance layer to the back of the internal circuit board 44. Moreover, the middle shell OMS 20 provides further protection by facilitating as an over-mold about the middle shell 16, enclosing its top wall, bottom wall, and sidewall perimeter edges.

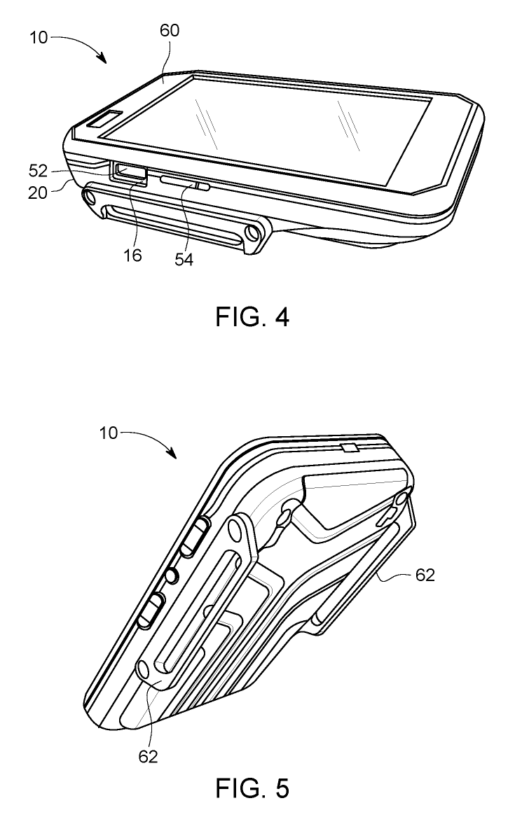

The middle shell OMS 20 defines openings that correspond to the middle shell openings 52, however with larger openings such that the middle shell 16 is primarily exposed about the corresponding opening 52, as shown in FIG. 4. The middle shell OMS 20 may further contain detachable covers 54 that can be inserted in a corresponding opening, and thereby provide a protective seal for the respective opening. For example, in the present embodiment, a detachable cover provides a liquid resistant seal for a SD card slot on the mobile device 10. However some openings, such as a USB port on the mobile device 10, are liquid resistant itself and thus do not require a detachable cover for protection. The middle shell OMS 20 can be constructed with thermoplastic polyurethane (TPU), which is a hybrid between a hard plastic and smooth silicone, and can provide high abrasion resistance, better low-temperature performance, high elasticity and high shear strength.

With continued reference to FIG. 2, and as aforementioned, the top shell 18 can include a top shell OMS 22. The top shell 18 is configured with a first bezel 58, that defines an opening 56 sized to fit the front perimeter of the mobile device screen 46, wherein the device screen 46 is secured to the first bezel. As such, the shells and device screen 46 together form a leak-proof enclosure that adequately seals the mobile device internal components. The first bezel surface 58 can further define a plurality of smaller openings for auxiliary features of the mobile device, such as a camera and/or light. The top shell 18 can be constructed with PC-ABS, thereby providing high impact resistance, high temperature resistance, and strong durability, among other properties. The top shell OMS 22 provides an over-mold that goes around and encloses the top wall, bottom wall, and sidewall perimeter edges of the top shell 18. The top shell OMS 22 can be constructed with TPU.

With reference to FIG. 2 and FIG. 4, the mobile device 10 further contains a second bezel 60 placed on top of the first bezel 58 and disposed within the top shell 18. The second bezel 60 is sized to fit within the hollowed perimeter of the top shell 18, and further contains surface dimensions that match the surface dimensions of the first bezel 58. The second bezel 60 surface further defines openings corresponding to the openings located on the first bezel 58 surface. The second bezel 60 can be constructed with polycarbonates, thereby providing an additional layer of impact resistant, heat resistant, highly durable material.

With reference to FIG. 2 and FIGS. 3A-3B, each battery 36, 38 is capable of powering the mobile device 10 by itself. As aforementioned, the internal battery 38, is in operative communication with the internal circuit 44 via the opening in the bottom portion of the middle shell 16. The internal battery 38 is inaccessible by the user. Conversely, a swappable battery 36 is located in a compartment enclosed by the top half of the bottom shell 14, and can be accessed via a battery door 48 provided on the bottom shell back cover 50. The swappable battery 36 can either be replaced with another battery, or be detached for charging, and re-inserted once fully charged. Both the internal battery 38 and swappable battery 36 can each power the mobile device. As such, the swappable battery 36 can be hot swapped, i.e. replaced while the mobile device remains powered through the internal battery 38. Thus, the user can extend the operation of a mobile device between charging requirements by carrying one or more fully charged swappable batteries.

With reference to FIGS. 1, 2, and 5, the mobile device 10 can contain two wings 62, wherein one wing is located on each side of the body. The wings 62 may be attached to the bottom shell 14, and affixed using screws that will be inserted through screw openings in the wings, and inserted into a corresponding threaded openings on the bottom shell 14. The wings 62 can be constructed with CNC metal. The wings 62 further enable the mobile device to be secured to a person's body, by inserting one or more straps 12, bands, and/or clasps through a perforation within each wing and about the person's body, such as a wrist.

It should be appreciated from the foregoing that the present invention provides a mobile device encapsulated with a plurality of layered, protective shells that provide impact resistance, liquid resistance, and durability when subject to turbulent environments. The mobile device further contains a hot swap, multiple battery configuration, wherein one of the batteries is detachable and replaceable with another fully charged battery while the mobile device remains powered, thereby enabling the user to forego the need for a power supply for an extended use of the mobile device. Moreover, the mobile device can contain wings attached to the device enclosure, wherein strap(s), band(s), and/or clasp(s) can be inserted within the wings and secured about a user's body, such as a wrist, providing the user with easy accessibility to the device.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

1-18. (canceled)

19. A mobile device, comprising:
a housing comprising impact resistant material, defines an interior compartment having a multi-layer configuration including:
a display layer at an upper facing of the housing, the display layer houses a display screen;
a battery layer in a lower side of the housing, the battery layer defining therein an internal battery compartment and a hot-swap battery compartment spaced apart from each other, the hot-swap battery compartment aligned with a removable section disposed on a rear facing of the housing;
a circuit layer disposed between the display layer and the battery layer, the circuit layer houses an internal circuit board with auxiliary components that provide computing power to the mobile device, and is in operative communication with the display screen;
an internal battery disposed within the internal battery compartment, and inaccessible outside of the housing, the internal battery coupled to the internal circuit board and configured to supply power thereto, the internal battery configured to individually power the mobile device;
a swappable battery disposed within the hot-swap battery compartment and removably coupled to the internal circuit board, enabling power supply thereto, the swappable battery accessible outside of the housing via the removable section, enabling for hot-swap of the swappable battery through continued power supply to the internal circuit board via the internal battery, the swappable battery configured to individually power the mobile device;
a physical barrier separating the internal battery compartment from the hot-swap battery compartment, such that the internal battery is inaccessible from the hot-swap battery compartment; and
a gasket assembly disposed between each layer of the multi-layer configuration, providing the housing with a leakproof configuration.

20. The mobile device as defined in claim 19, wherein the housing is constructed with polycarbonate and acrylonitrile-butadiene-styrene.

21. The mobile device as defined in claim 20, further comprising an over-mold shell enclosing the housing about the display and circuit layers, the over-mold shell constructed with thermoplastic polyurethane.

22. The mobile device as defined in claim 19, wherein the display screen is disposed within a bezel, defining a display region, such that the bezel protrudes from the display region at the upper facing.

23. (canceled)

24. The mobile device as defined in claim 19, wherein the layers in the multi-layer configuration are secured to one another using a plurality of screws.

25. The mobile device as defined in claim 24, wherein the plurality of screws are affixed to the display layer, so as to be inserted through corresponding perforations disposed in the battery and circuit layers.

26. The mobile device as defined in claim 19, further comprising a plurality of wings affixed to the housing, each wing of the plurality of wings defining a perforation, such that a fastener inserted through the perforations of the plurality of wings can be disposed about a user, thereby securing the device enclosure to a user.

27. The mobile device as defined in claim 26, wherein the fastener is selected from the group consisting of one or more clasps, one or more straps, and one or more bands.
